(19) United States
(12) Patent Application Publication
(10) Pub. No.: US 2012/0268948 A1
(43) Pub. Date: Oct. 25, 2012

(54) LIGHTING CONTROL APPARATUS AND METHOD

(76) Inventor: Michael D. YODER, Dayton, MD (US)

(21) Appl. No.: 13/089,739

(22) Filed: Apr. 19, 2011

(51) Int. Cl. F21V 17/02; F21V 7/04; F21V 11/00; F21V 7/00

(52) U.S. Cl. 362/319; 362/341; 362/347; 362/346; 362/351

(57) ABSTRACT

A lighting control apparatus, comprising a shield having a reflective inner surface that blocks light emanating from a light fixture in a first direction, and redirects light emanating from the light fixture to a second direction; a clamp attached to the socket of the light fixture and deriving support therefrom; and a support structure attached to the clamp that supports the shield in a position suitable for blocking and redirecting the light emanating from the light fixture

### BACKGROUND

Many existing light fixtures, including outdoor post-top type fixtures, fail to properly control light as it leaves the fixture. Outdoor light fixtures have an expected life rating of 30 years or more, and many outdoor light fixtures were designed and installed prior to today's sensitivity to dark skies and light trespass regulations.

Most existing fixtures offer very little in the way of lighting control. In some cases a lighting reflector is not part of the existing fixture. In other cases a minimally efficient reflector or refractor is part of the fixture and may or may not be removable. This inability to properly control light results in illuminating undesirable areas and inefficiently illuminating the target area. Examples of undesirable lighting are urban sky glow, light trespass, and glare. Existing solutions often require replacement of multiple components of the fixtures, resulting in a great increase in cost and complexity.

### SUMMARY

In one exemplary embodiment, a lighting control apparatus may be disclosed. The apparatus can have a shield having a reflective inner surface that blocks light emanating from a light fixture in a first direction, and redirects light emanating from the light fixture to a second direction; a clamp attached to the socket of the light fixture; and a support structure attached to the clamp that supports the shield.

In another exemplary embodiment, another lighting control apparatus may be described. The lighting control apparatus can have a shield having a reflective inner surface that blocks light emanating from a light fixture in a first direction, and redirects light emanating from the light fixture to a second direction; a clamp attached directly to the lamp of the light fixture, that supports the shield in a position suitable for blocking and redirecting the light emanating from the light fixture.

In another exemplary embodiment, a lighting control apparatus can be described. The apparatus can have a means for blocking light emanating from a lighting fixture, and a means for attaching the light-blocking means to the light fixture.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1A is a side view of an exemplary embodiment of a lighting control device.

FIG. 1B is a front view of an exemplary embodiment of a lighting control device.

FIG. 2A is a side view of an exemplary embodiment of a lighting control device attached to an exemplary light fixture.

FIG. 2B is a rear view of an exemplary embodiment of a lighting control device attached to an exemplary light fixture.

FIG. 2C is a front view of an exemplary embodiment of a lighting control device attached to an exemplary light fixture.

FIG. 3A is a side view of an exemplary embodiment of a secondary shield attached to an exemplary embodiment of a lighting control device.

FIG. 3B is a front view of an exemplary embodiment of a secondary shield attached to an exemplary embodiment of a lighting control device.

FIG. 4A is a side view of an exemplary embodiment of a lighting control device with an exemplary secondary shield attached to an exemplary light fixture.

FIG. 4B is a rear view of an exemplary embodiment of a lighting control device with an exemplary secondary shield attached to an exemplary light fixture.

FIG. 4C is a front view of an exemplary embodiment of a lighting control device with an exemplary secondary shield attached to an exemplary light fixture.

FIG. 5A is a side view of an exemplary embodiment of a lighting control device.

FIG. 5B is a front view of an exemplary embodiment of a lighting control device.

FIG. 6A is a side view of an exemplary embodiment of a lighting control device attached to an exemplary light fixture.

FIG. 6B is a rear view of an exemplary embodiment of a lighting control device attached to an exemplary light fixture.

FIG. 6C is a front view of an exemplary embodiment of a lighting control device attached to an exemplary light fixture.

FIG. 7A is a side view of an exemplary embodiment of a secondary shield attached to an exemplary embodiment of a lighting control device.

FIG. 7B is a front view of an exemplary embodiment of a secondary shield attached to an exemplary embodiment of a lighting control device.

FIG. 8A is a side view of an exemplary embodiment of a lighting control device with an exemplary secondary shield attached to an exemplary light fixture.

FIG. 8B is a rear view of an exemplary embodiment of a lighting control device with an exemplary secondary shield attached to an exemplary light fixture.

FIG. 8C is a front view of an exemplary embodiment of a lighting control device with an exemplary secondary shield attached to an exemplary light fixture.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation. “Data” should be understood to be any information in either organized or unorganized form and in any format.

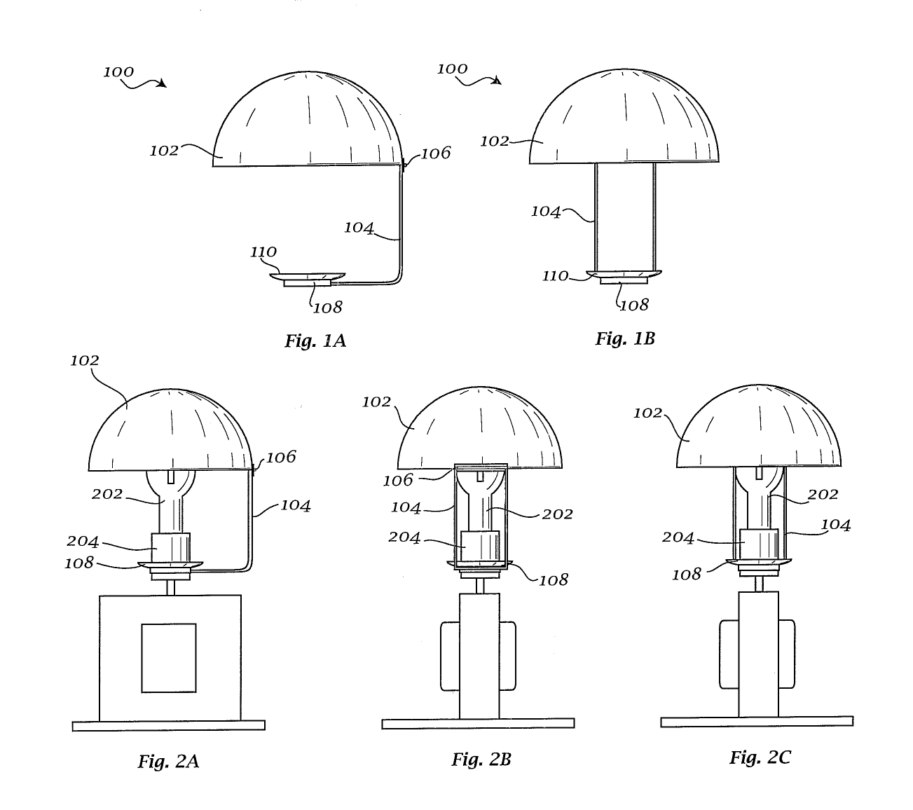

Generally referring to exemplary FIGS. 1A-8C, embodiments described herein may include lighting control and efficiency enhancing devices that can be attached to existing light fixtures. Once installed, the devices can control the light emitted from the fixture's lamp, cutting down on nuisance light and increasing the fixture's overall efficiency. The devices can block a majority of the uncontrolled light leaving the fixtures and redirect it to a desired target. By redirecting the light, the fixtures' overall efficiency can be increased, which can in some cases allow a lower wattage lamp to be used to save energy.

FIG. 1A illustrates a side view and FIG. 1B illustrates a front view of an exemplary embodiment of lighting control device 100. Lighting control device 100 can contain primary shield 102. Primary shield 102 can reduce the amount of light projected upward by a light fixture's lamp by blocking the light emanated in an upward direction, and collecting and redirecting this light as desired in a downward direction, for instance onto a sidewalk or roadway area. Primary shield 102 can be a hemispherical dome or any other type of dome, or any other shape as desired. Different sizes and shapes of primary shield 102 can provide different blocking, collecting, and redirecting patterns, allowing the user of lighting control device 100 to adjust the amount and direction of light that is blocked, collected, and redirected. Primary shield 102 can be constructed of any material, for instance anodized aluminum sheet metal. The inner surface of primary shield 102 can be reflective. Lighting control device 100 can also contain support arm 104. Support arm 104 can be constructed of metal, plastic, for example heat-tolerant plastic, or any other desired material. Support arm 104 can be attached to primary shield 102 directly, through hinge 106, or by any other desired attachment means. Lighting control device 100 can also contain socket attachment clamp 108. Socket attachment clamp 108 can be adapted to engage and attach to the socket of a light fixture. Lighting control device 100 can also contain a bottom shield 110.

FIG. 2A is an exemplary illustration of a side view of an exemplary embodiment of lighting control device 100 as installed in an exemplary light fixture. FIG. 2B illustrates a rear view of the same. FIG. 2C illustrates a front view of the same. Socket attachment clamp 108 can be attached to the fixture's socket 204. Socket attachment clamp 108 can support support arm 104, which can in turn support primary shield 102. When primary shield 102 is in the operative position, as shown in FIGS. 2A-C, it can reduce the amount of light projected upward by lamp 202 by collecting and redirecting this light as desired in a downward direction, for instance onto a sidewalk or roadway area. Primary shield 102 can be adjusted up, which can increase the amount of light that escapes upward and outward, or down, which can increase the amount of light redirected downward. Hinge 106 can allow primary shield 102 to be rotated rearward in order to allow lamp 202 to be installed in or removed from socket 2024

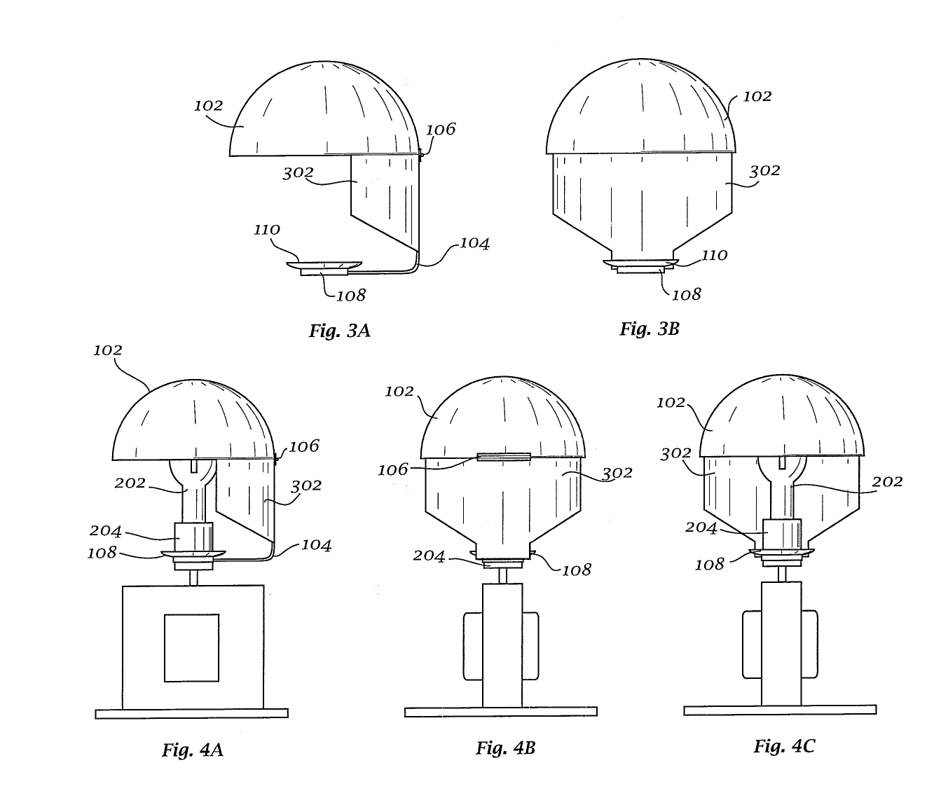

FIGS. 3A and 3B show illustrations of an exemplary embodiment of lighting control device 100 with an exemplary embodiment of an optional secondary shield 302 removably attached. Secondary shield 302 can block light that would previously have spilled laterally onto a property or home that may find this light undesirable. By blocking, collecting, and redirecting this light to a more useful or desired area, the fixture's overall efficiency can be increased. Secondary shield 302 can be constructed of any material, for example anodized aluminum sheet metal. The inner surface of secondary shield 302 can be reflective. Secondary shield 302 can be fitted to lighting control 100 by attaching to primary shield 102, support arm 104, hinge 106, socket attachment clamp 108, or in any other manner. Secondary shield 302 can be attached to lighting control device 100 with screws, snaps, hinges, or any other desired attachment method. Secondary shield 302 can be any size or shape, and can attach to lighting control device 100 at any angle. Different sizes and shapes of secondary shield 302 can provide different blocking and reflection patterns, allowing the user of lighting control device 100 to adjust the amount and direction of light that is blocked, collected, and redirected by lighting control device 100. Secondary shield 302 can, for example, cover an angular range around the light fixture, for example ninety degrees, one-hundred-eighty degrees, two-hundred-seventy degrees, or any other desired range. The angle and position of secondary shield 302 can also be adjusted to regulate the amount and direction of light that is blocked, collected, and redirected by lighting control device 100. For example, adjustment of secondary shield 302 may be made by way of a hinge, a slidable fitting coupled to primary shield 102 or any other desired manner of adjustment.

FIG. 4A illustrates a side view of an exemplary embodiment of secondary shield 302 removably attached to an exemplary embodiment of lighting control device 100 as installed in an exemplary light fixture. FIG. 4B illustrates a rear view of the same. FIG. 4C illustrates a front view of the same.

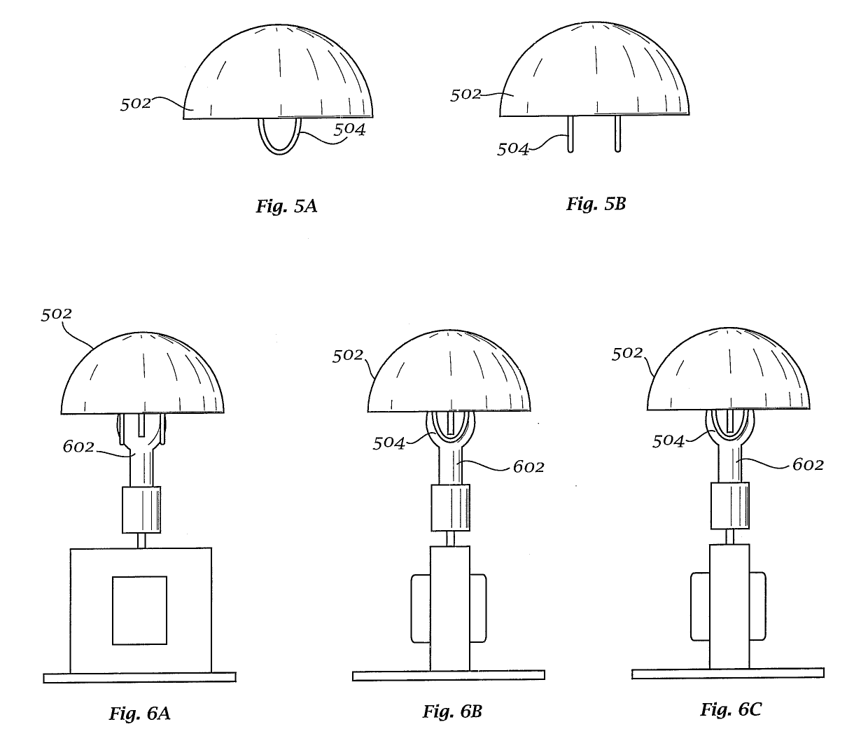

FIG. 5A illustrates a front view and FIG. 5B illustrates a side view of another exemplary embodiment of lighting control device 100. Lighting control device 100 can contain primary shield 502. Primary shield 502 can reduce the amount of light projected upward by a light fixture's lamp by blocking the light emanated in an upward direction, and collecting and redirecting this light as desired in a downward direction, for instance onto a sidewalk or roadway area. Primary shield 502 can be a hemispherical dome or any other type of dome, or any other shape. Different sizes and shapes of primary shield 502 can provide different blocking, collecting, and redirecting patterns, allowing the user of lighting control device 100 to adjust the amount and direction of light that is blocked, collected, and redirected. Primary shield 502 can be constructed of any material, for instance anodized aluminum sheet metal. The inner surface of primary shield 502 can be reflective. Lighting control device 100 can also contain clamps 504. Clamps 504 can be constructed of any material, for example metal wire or springs, or wire or springs made of a synthetic material, for example heat-tolerant plastic. Clamps 504 can be formed in any shape, for example ovals or circles. Clamps 504 can attach directly to the lamp of a light fixture and provide support for primary shield 502.

FIG. 6A is an exemplary illustration of a side view of an exemplary embodiment of lighting control device 100 as installed in an exemplary light fixture. FIG. 6B illustrates a rear view of the same. FIG. 6C illustrates a front view of the same. Clamps 504 can be placed directly onto the fixture's lamp 602, securing lighting control device in place by the force of friction provided by the squeezing action of Clamps 504. Clamps 504 can support primary shield 502.

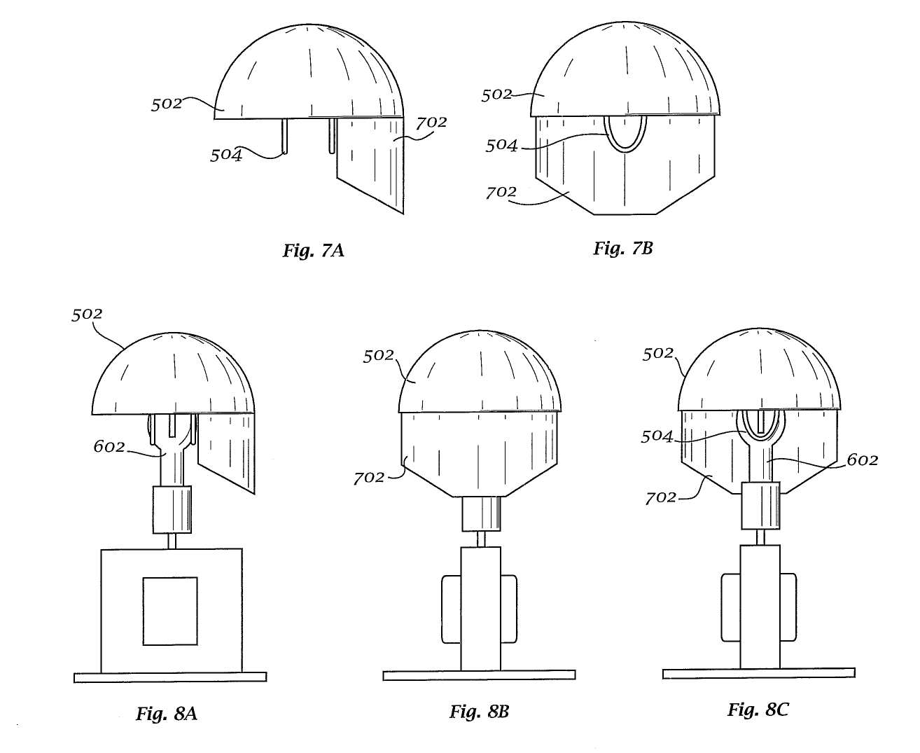

FIGS. 7A and 7B show illustrations of an exemplary embodiment of lighting control device 100 with an exemplary embodiment of secondary shield 702 removably attached. Secondary shield 702 can block the light that would previously have spilled onto a property or home that finds this light undesirable. By blocking, collecting, and redirecting this light to a more useful area, the fixture's overall efficiency can be increased. Secondary shield 702 can be fitted to lighting control 100 by attaching to primary shield 502, to clamps 504, or in any other manner. Secondary shield 702 can be attached to lighting control device 100 with screws, snaps, hinges, or any other desired attachment method. Secondary shield 702 can be constructed of any material, for instance anodized aluminum sheet metal. The inner surface of secondary shield 702 can be reflective. Secondary shield 702 can be any size or shape, and can attach to lighting control device 100 at any angle. Different sizes and shapes of secondary shield 702 can provide different blocking and reflection patterns, allowing the user of lighting control device 100 to adjust the amount and direction of light that is blocked, collected, and redirected by lighting control device 100. Secondary shield 702 can for instance, cover an angular range around the light fixture, for example ninety degrees, one-hundred-eighty degrees, two-hundred-seventy degrees, or any other desired range. The angle and position of secondary shield 702 can also be adjusted to regulate the amount and direction of light that is blocked, collected, and redirected by lighting control device 100.

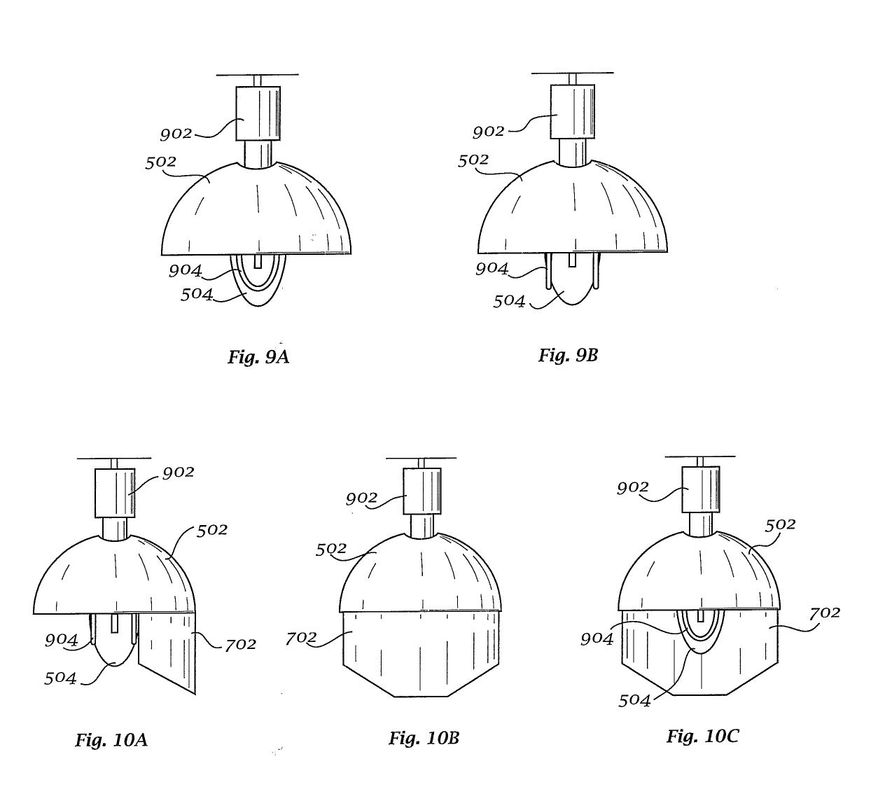

FIG. 8A illustrates a side view of an exemplary embodiment of secondary shield 702 removably attached to an exemplary embodiment of lighting control device 100 as installed in an exemplary light fixture. FIG. 8B illustrates a rear view of the same. FIG. 8C illustrates a front view of the same.

FIG. 9A is an exemplary illustration of a front view of an exemplary embodiment of lighting control device 100 as installed in an exemplary light fixture. FIG. 9B illustrates a side view of the same. Primary shield 502 can be shaped to allow lamp 904 to extend through it when clamps 504 are secured to lamp 904. This can allow primary shield 502 to block, collect, and redirect light as desired when socket 902 is oriented above lamp 904, to one side of lamp 904, or in any other orientation with respect to lamp 904.

FIG. 10A illustrates a side view of an exemplary embodiment of secondary shield 702 removably attached to an exemplary embodiment of lighting control device 100 as installed in an exemplary light fixture. FIG. 10B illustrates a rear view of the same. FIG. 10C illustrates a front view of the same.

Lighting control device 100 can be attached to or used with any desired type of lighting fixture. According to certain embodiments, primary shields 102 and 502 need not be located above a light fixture, and can be oriented in any position in relation to the lamp of the light fixture to which they are attached, for instance on the side or underneath, in order to block collect, and redirect the light emanated in a desired pattern. Lighting control device 100 can be constructed of any desired material, for instance natural materials such as wood or stone, synthetic materials such as heat-tolerant plastic or rubber, or any type of metal.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A lighting control apparatus, comprising:
a shield having a reflective inner surface that blocks light emanating from a light fixture in a first direction, and redirects light emanating from the light fixture to a second direction;
a clamp attached to the socket of the light fixture and deriving support therefrom; and
a support structure attached to the clamp that supports the shield in a position suitable for blocking and redirecting the light emanating from the light fixture.

2. The apparatus of claim 1, wherein the shield is constructed of aluminum sheet metal.

3. The apparatus of claim 1, wherein the shield is a substantially hemispherical dome.

4. The apparatus of claim 1, wherein the support structure positions the shield above the light fixture to block light emanating therefrom in a substantially upward upward direction, and redirects light emanating therefrom to a substantially downward direction.

5. The apparatus of claim 1, further comprising a secondary shield removably coupled to the lighting control apparatus and having a reflective inner surface that blocks and redirects light emanating from the light fixture in a different direction.

6. The apparatus of claim 5, wherein the secondary shield is located to one side of the light fixture, allowing the shield to block and redirect light emanating therefrom substantially laterally.

7. The apparatus of claim 6, wherein the secondary shield covers a certain angular range around the lighting control apparatus, the angular range being from about ninety degrees to two-hundred-seventy degrees.

8. A lighting control apparatus, comprising:
a shield having a reflective inner surface that blocks light emanating from a light fixture in a first direction, and redirects light emanating from the light fixture to a second direction;
a clamp attached directly to the lamp of the light fixture, that supports the shield in a position suitable for blocking and redirecting the light emanating from the light fixture.

9. The apparatus of claim 8, wherein the shield is constructed of aluminum sheet metal.

10. The apparatus of claim 8, wherein the shield is a substantially hemispherical dome.

11. The apparatus of claim 8, wherein the clamp positions the shield above the light fixture to block light emanating therefrom in a substantially upward direction, and redirects light emanating therefrom to a substantially downward direction.

12. The apparatus of claim 8, further comprising a secondary shield removably attached to the lighting control apparatus and having a reflective inner surface that blocks and redirects light emanating from the light fixture in a different direction.

13. The apparatus of claim 12, in which the secondary shield is located to one side of the light fixture, allowing the shield to block and redirect light emanating therefrom substantially laterally.

14. The apparatus of claim 13, wherein the secondary shield covers a certain angular range around the lighting control apparatus, the angular range being from about ninety degrees to two-hundred-seventy degrees.

15. A lighting control apparatus, comprising a means for blocking light emanating from a light fixture, and a means for attaching the light-blocking means to the light fixture.

16. The apparatus of claim 15, further comprising a means for adjusting the position of the light-blocking means in relation to the light fixture.
